(19) United States
(12) Patent Application Publication
(10) Pub. No.: US 2020/0012314 A1
(43) Pub. Date: Jan. 9, 2020

(54) Portable stand for electronic device

(71) Applicant: Shun Chang, Union City, CA (US)

(72) Inventor: Shun Chang, Union City, CA (US)

(21) Appl. No.: 15/880,148

(22) Filed: Jan. 25, 2018

(51) Int. Cl. G06F 1/16

(52) U.S. Cl. CPC G06F 1/1607; A45C 2011/002; G06F 1/166

(57) ABSTRACT

The present invention discloses a holder for electronic devices. The electronic device holder may be affixed to a solid object, such as a bed, a kitchen counter, a desk, or other object. The invention includes multiple arms, which rotate with respect to one another. The invention is also capable of rotating with respect to the object to which it is affixed. In that manner, the tablet or other electronic device may be held at a height and angle that maximizes versatility ad convenience to the user. The invention may be easily folded and stored out of sight when not in use.

### FIELD OF THE INVENTION

The present invention discloses a holder for electronic devices. The electronic device holder may be affixed to a solid object, such as a bed, a kitchen counter, a desk, or other object. The invention includes multiple arms, which rotate with respect to one another. The invention is also capable of rotating with respect to the object to which it is affixed. In that manner, the tablet or other electronic device may be held at a height and angle that maximizes versatility ad convenience to the user. The invention may be easily folded and stored out of sight when not in use.

### BACKGROUND OF THE INVENTION

Portable electronic devices, such as tablets, smart phones or other computing devices are widely used for various applications. It is often desirable to be able to view the screen of such devices without having to hold the device in hand. For example, it is common to want to watch movies or other entertainment on a tablet screen while sitting or lying down. Likewise, it may be desirable to view a recipe on a tablet screen while cooking. It also may be desirable to position an electronic device at a desired angle for preferred viewing or listening while sitting at a desk. For those and other activities, it is preferred that the tablet remains stable without the user having to stabilize it with his or her hands.

There exist tablet and electronic holders in the marketplace for portable electronic devices. However, such devices are generally constructed to rest on a surface in one position. Those devices have the drawback that they are not easily positioned to accommodate users who wish to lie down, to move from one part of the room to another, or to otherwise view the electronic device from a variety of angles.

In addition, there remains a need for a device holder that may be easily folded and placed out of sight when not in use. There further remains a need for a device holder that allows the electronic device to be easily detached and transported.

### SUMMARY OF THE INVENTION

The current invention addresses the foregoing issues and drawbacks, and solves other need as described herein.

The current invention comprises a multi-arm, highly adjustable holder for portable electronic devices. The device includes a cradle that secures the portable electronic device. For example, an iPad or other tablet, smart phone, or portable device may be inserted into the cradle, and held in place.

In one embodiment, the cradle is attached to an arm, which is referred to herein out as a second arm, via a click and lock mechanism. That click and lock mechanism is in turn connected to a ball joint. The ball joint allows the cradle to be positioned at an angle of the user's choosing. The cradle may be locked into a particular position so that it is held secure in the position of the user's choosing.

The first arm is attached to a second arm by means of a flexible joint. That flexible joint allows the two arms to pivot both vertically and horizontally with respect to one another. In addition, the joint allows the arms to fold for storage, such that they are lying parallel to one another and touching, thereby taking up a minimum of space. In different embodiments the arms may be the same lengths, or one arm may be longer or shorter than the other arm. That provides for additional flexibility and allows the device to be used in multiple locations and situations.

The first arm is attached to a clamp, or other similar mechanism that allows the device to be attached to a fixed object. For example, the clamp may be affixed to a bed frame, a desk or a cabinet. In one embodiment, the clamp may be affixed to a flat metal piece. That piece may be used when the user desires to attach the device to a bed, but there is no bedframe to which the clamp may be attached. In that scenario, the metal piece may be inserted between the mattress and box spring, and the device of the present invention will be held securely in place.

In that manner, a user may lie in bed and position the tablet such that the screen is at an optimal angle for viewing. The user may then watch movies or television shows, or otherwise read or engage with the tablet, without having to hold it steady with their hands. Other examples of the manner in which the device may be used are provided herein.

The device of the present invention includes a push button release, such that the cradle may be removed from the arm assembly with ease. The user may press a button that is located on the backside of the cradle and/or on the locking disc. Once pressed, the button releases the cradle from the assembly. The arm assembly may then be folded for easy storage, and the electronic device may easily be moved.

### BRIEF DESCRIPTION OF THE DRAWINGS

FIG. 1 depicts a side view of the present invention.

FIG. 2 depicts the click and lock mechanism of the present invention.

FIG. 3 depicts the joint adjoining the first and second arms of the present invention.

FIG. 4 depicts the clamp of the present invention.

FIG. 5 depicts the present invention attached to a desk.

FIG. 6 depicts the present invention attached beneath a cabinet.

FIG. 7 depicts the device of the present invention secured to a bed.

### DETAILED DESCRIPTION OF THE PREFERRED EMBODIMENTS

The current invention is now described with reference to the figures. Components appearing in more than one figure bear the same reference numerals.

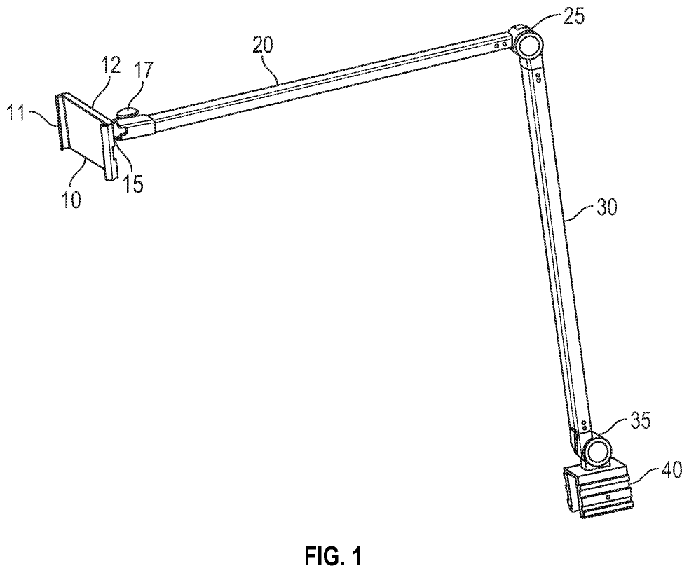

FIG. 1 depicts the device of the present invention. The electronic device, such as a tablet or smart phone or other portable electronic device may be slid into and held secure in cradle 10. Cradle 10 may be extended or collapsed in a vertical direction in order to accommodate devices of different sizes. In a preferred embodiment, the back wall of cradle 10 may be comprised of two pieces, attached to one another by a spring. The spring allows cradle 10 to expand and contract in order to accommodate devices of varying widths.

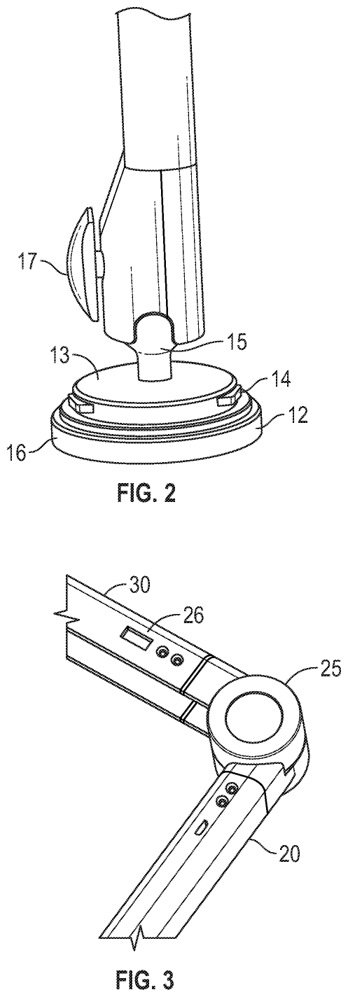

Cradle 10 is attached to a click and lock mechanism as discussed more fully in connection with FIG. 2 below. The click and lock mechanism is attached to a joint 15. Joint 15 may preferably be a ball joint, in order to allow for maximum flexibility and versatility. Joint 15 attaches the cradle and click and lock mechanism to second arm 20. Second arm 20 is attached to first arm 30, by means of joint 25. Joint 25 may preferably allow second arm 20 and first arm 30 180 degrees in the vertical direction respect to each other, and 360 degrees in the horizontal direction.

Second arm 30 is attached to attachment means 40 by joint 35. Joint 35 may preferably pivot 180 degrees in order to allow for maximum flexibility, and as discussed herein, to provide for easy storage and deployment into use. Attachment means 40 may preferably consist of a clamp and metal plate attachment. The clamp allows the device of the present invention to be affixed to a solid object such as a railing of a bed frame or other piece of furniture or household element.

As shown, cradle 10 includes guard walls 11. The electronic device may easily be slid into the cradle, and held in place by guard walls 11. As discussed herein, the width of cradle 10 is adjustable such that it may accommodate devices of varying widths.

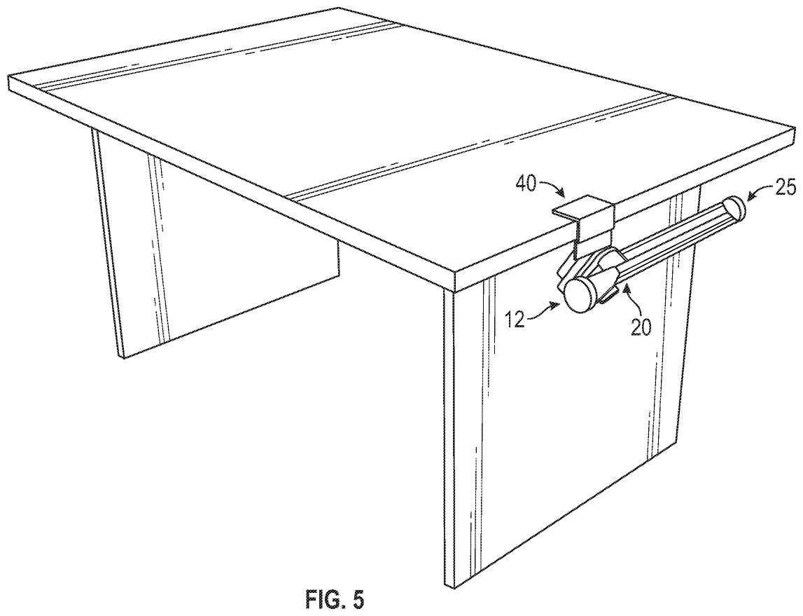

Due to the flexibility of joint 25, arm 20 may be folded such that it lies flat against arm 30 when the device is not in use. Joint 35 then allows the device to be folded so that it might lie in a flat position for storage. As discussed further below in connection with FIG. 5, the device may be clamped onto an object such that it hangs beneath the object when not in use. Then, due to the flexibility of joint 35, the device may be pivoted so that it is parallel to the desk or other object, and the arms may be raised and placed into the desired position. For example, the device may be clamped or otherwise affixed to the side of a desk. When the user wishes to place the device into use, he or she may raise the arms up, and place them in the desired position. Joint 25 may pivot 360 degrees such that arm 20 may swing on a circular axis, to be placed where desired.

FIG. 2 depicts in more detail the manner in which cradle 10 is attached to second arm 20. Cradle 10 may be attached to click and lock mechanism 16. The click and lock mechanism includes disc 12. One side of disc 12 attaches to the back of cradle 10, while the other side is attached to disc 13. Disc 12 may preferably have a sticky surface that allows it to be easily affixed to cradle 10. For example, disc 12 may have a heavy duty double sided tape, or other known fixative material, applied to its surface. Button 14 may be located on disc 13 as shown in the figure. FIG. 2 depicts an embodiment in which button 14 consists of two opposing buttons on either side of the disc. In other embodiments, button 14 may consist of a single button. When button 14 is pressed, cradle 10 and disc 12 are released from disc 13 and from the arm assembly attached to disc 13.

FIG. 2 further depicts locking mechanism 17. Locking mechanism 17 serves to lock joint 15 into the desired position. The user is able to freely adjust any angles with joint 15. When the locking mechanism is tightened, the cradle is fixed at the user's preferred angle. In order to change the position, the user may loosen locking mechanism 17 and move cradle 20 to a different angle. Other locking mechanisms apart from the one depicted in FIG. 2 may also be used. For example, the locking mechanism might consist of a button or a lever that may be slid or toggled. Other mechanisms known in the art may also be used.

Reference is now made to FIG. 3. This figure depicts joint 25 that attaches second arm 20 to first arm 30. Joint 25 preferably allows second arm 20 and first arm 30 to rotate 360 degrees horizontally with respect to one another, and 180 degrees vertically. Due to that ability to rotate, the arms may be positioned parallel to one another when the device is not in use. In addition, the arms may be placed at varying angles with respect to one another when the device is placed into use.

When the arms are parallel to one another, they are preferably stacked on top of each other. In that configuration, the device may be easily stored. For example, if the device is clamed to a bed frame, the device may be folded and stored on the arm of the bed frame. Alternatively, it may be folded and stored on the floor along side or underneath the bed. In all of those examples, the device will take up a minimum of space. It may easily be covered by bedding, such that it is not visible when it is stored. Then, when the user desires to place it into use, the user simply lifts the arms to raise the device into the desired position. The device may be placed at a desired height and angle due to the fact that joint 25 rotates 180 degrees in the vertical direction. The user then may swing arm 20 in a horizontal direction to the desired location.

The arms of the device further include USB ports 26. In different embodiments, the device may include one or more such ports. The ports may be located on arm 20 or arm 30, or on both arms.

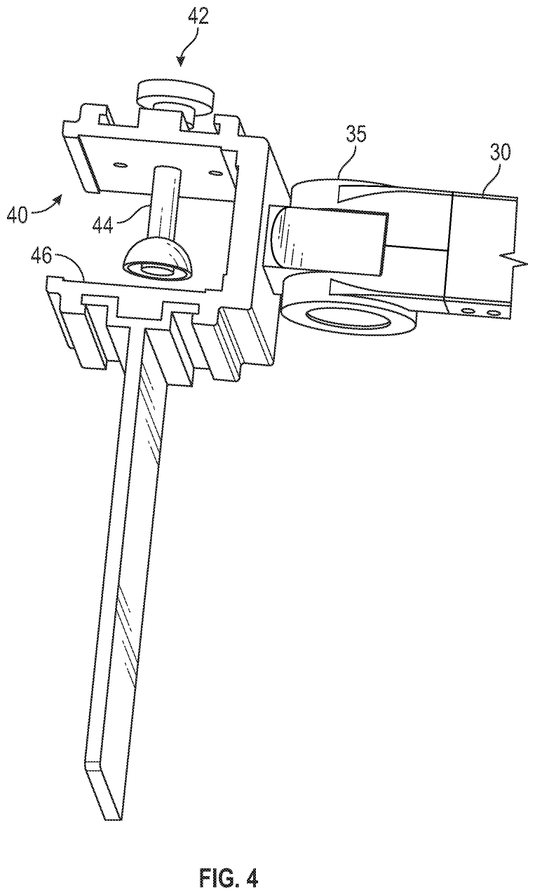

Reference will now be made with respect to FIG. 4. This figure depicts attachment means 40. In the depicted embodiment, attachment means 40 takes the form of a clamp. In this embodiment, when handle 42 is turned, rod 44 moves either toward wall 46 or away from wall 46, depending on the direction in which handle 42 is turned. Attachment means 40 may be placed around a bed rail or other solid object and handle 42 may be turned in order to fix the device in place. When the user wishes to move the device, handle 42 is easily turned to loosen the clamp, such that the device may be moved again. Other attachment means known in the art may also be used in place of the depicted clamp.

FIGS. 5, 6, and 7 depict examples of the way in which the device may be used. FIG. 5 depicts the device of the present invention as attached to a desk, such as an office desk. As shown in the figure, the device may be clamped or affixed to the side of a desk. When it is not in use, the device hangs beneath the desk and largely out of sight. In that manner, the device does not take up work space when not in use. When placed into use, the device may be pivoted upward on joint 35 and then extended and placed into the desired position.

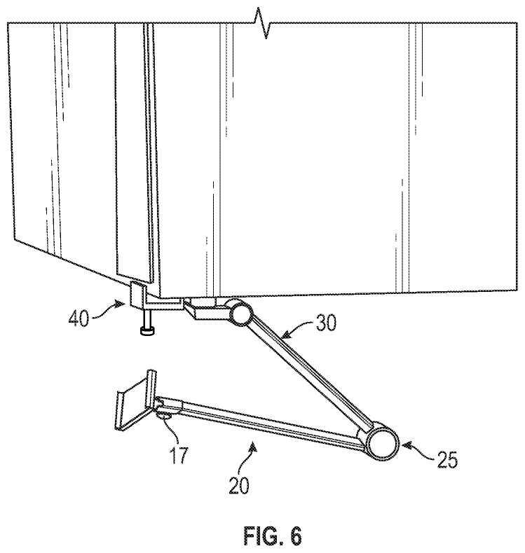

FIG. 6 depicts the device of the present invention as attached to the side of a kitchen cabinet. Just as with the desk, the device may be folded and hang largely out of sight when not in use. When the device is placed into use, arm 30 may be swung outward, and arm 30 may pivot outward and either up or down. In the example of the kitchen cabinet, the user will likely want to pivot arm 20 in a downward direction. In that manner, the portable electronic device may be placed at or near eye level for easy viewing. Arm 30 may also be swung in a horizontal direction such that the device may easily be moved into a new position for easy viewing from a different location in the room. The user may then view recipes, watch television, or otherwise use the device when cooking, washing dishes, or engaging in other kitchen activities.

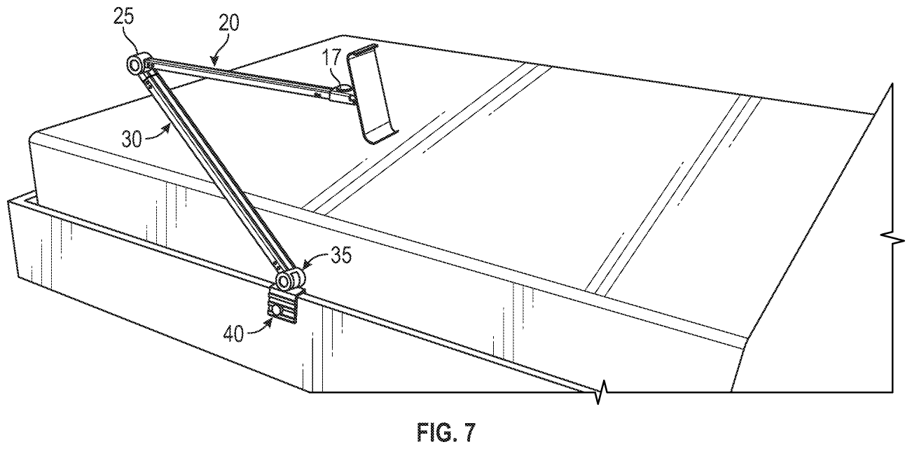

FIG. 7 depicts the device of the present invention as attached to a bed frame. The device may be easily stored in a flat position, where it will not impede the user when not in use. It may then be swung or pivoted on joint 35, and the arms may easily be extended and placed into the desired position.

The above embodiments are exemplary, and other methods and structures may be employed to achieve the same end.

1. An electronic device holder comprising:
a cradle designed to fit around an electronic device;
a first arm;
a second arm; and
a means for attaching said electronic device holder to a solid object.

2. The electronic device holder of claim 1 wherein a disc is attached to the back of said cradle.

3. The electronic device holder of claim 2 wherein said disc is also attached to a click and lock mechanism.

4. The electronic device holder of claim 1 wherein said second arm is attached to a ball joint.

5. The electronic device holder of claim 1 wherein said first arm and said second arm are attached by a flexible joint.

6. The electronic device holder of claim 5 wherein said flexible joint holds said first arm and said second arm in a desired position relative to one another.

7. The electronic device holder of claim 1 wherein said means for attaching said electronic device holder to a solid object comprises a clamp.

8. The electronic device holder of claim 1 wherein said first arm includes a USB port.

9. The electronic device holder of claim 1 wherein said second arm includes a USB port.

10. The electronic device holder of claim 1 wherein said cradle may be collapsed or extended in a vertical direction.
